(19) United States
(12) Patent Application Publication
(10) Pub. No.: US 2006/0027065 A1
(43) Pub. Date: Feb. 9, 2006

(54) Unit for feeding and cutting into lengths a strip of wrapping material

(76) Inventor: Mario Spatafora, Granarolo (IT)

Correspondence Address: Harbin King & Klima, 500 Ninth Street SE, Washington, DC, 20003, US

(21) Appl. No.: 11/195,646

(22) Filed: Aug. 3, 2005

(30) Foreign Application Priority Data
Aug. 9, 2004 (IT) BO2004A000522

(51) Int. Cl. B26D 1/00

(52) U.S. Cl. 83/13

(57) ABSTRACT

Single lengths of wrapping material are cut from a continuous strip by a feed unit equipped with a drum on which the strip is taken up and advanced, also with a first cutter assembly by which the strip is divided into leaves, a second cutter assembly positioned to score a transverse tear-off line on each leaf, and a third cutter assembly positioned to score a longitudinal tear-off line that combines with the transverse tear-off line to mark out a removable portion of the leaf; the first and second and third cutter assemblies all operate in conjunction with the drum, the second and third assemblies being also rigidly associated one with another, incorporated into a single rotary device in such a way as to present a cutting edge of “L” shape designed to interact at one and the same station with a striking surface offered by the drum.

### BACKGROUND OF THE INVENTION

The present invention relates to a unit for feeding and cutting into discrete lengths a strip of wrapping material. The lengths of material thus obtained are utilized in a machine for packaging commodities.

Units of the type in question are used typically to cut a continuous strip of metal foil paper into single leaves, which are then fed to the wrapping unit of a cigarette packer and folded each directly around a respective group of cigarettes to form an inner wrapper in a finished packet of substantially parallelepiped appearance.

The leaves of metal foil paper are generated by making transverse cuts through the strip and appear rectangular in outline, the predominating dimension aligned on the axis of the strip. Each single leaf presents a corner area with two tear-off lines, one longitudinal, one transverse, combining to delimit a rectangular portion known as a “pull”, which can be removed by the user at the moment of breaking open the packet of cigarettes.

Conventionally, feeding and cutting devices used to generate the single leaves of material comprise a first roller and a second roller rotatable about mutually parallel axes in opposite directions, each of which is equipped with two diametrically opposed blades extending parallel to the axes of rotation.

The first roller has an aspirating cylindrical surface, and besides functioning as a reaction or anvil element in the cutting step, serves also to advance the strip of metal foil paper decoiled from a roll and to convey the leaves separated by the cutting action toward a further processing station.

The two blades of a first pair mounted one to the first roller and one to the second, substantially equal in length to the transverse dimension of the strip, serve to make the cut by which the leaf is separated from the strip.

The blades of a second pair serve to impress or score the transverse tear-off line aforementioned.

Also forming a part of the feeding and cutting device is a disc cutter rotatable about an axis parallel to the axes of the two rollers, operating in combination with the first roller to impress the longitudinal tear-off line aforementioned. In the conventional feeding and cutting devices outlined above, accordingly, each transverse tear-off line occupies an intermediate position, located between and at a given distance from the two shorter cut edges of the rectangular leaf.

With a device of the type described above, there is no proper control over the point at which the aforementioned transverse and longitudinal tear-off lines of the pull portion are supposed to meet, and it can happen that the corresponding ends of these same two lines, defining the internal corner of the pull portion, will overlap or drift positionally one relative to the other with the result that the pull portion is rendered potentially unstable or liable to produce an unwanted tear when removed at the moment of breaking open the packet.

It can also happen, for example when changing from one type of metal foil strip to another, or changing from one size of product to another, that the entire feeding and cutting unit likewise will need to be changed over.

The object of the present invention is to set forth a unit for feeding and cutting into discrete lengths a strip of wrapping material, such as will be unaffected by the drawbacks described above.

### SUMMARY OF THE INVENTION

The stated object is realized according to the present invention in a unit for feeding and cutting into discrete lengths a strip of wrapping material, comprising a conveyor on which to support and advance the strip, first cutting means, cyclical in operation, by which the strip is divided transversely into single leaves of predetermined length, second cutting means, cyclical in operation, serving to score at least one transverse tear-off line on each leaf, and third cutting means serving to score a longitudinal tear-off line combining with the transverse tear-off line to delimit a removable portion of the leaf, wherein the first and second and third cutting means operate in conjunction with the conveyor supporting and advancing the strip.

In the unit disclosed, the second and third cutting means are rigidly associated one with another and form part of a common rotary device.

### BRIEF DESCRIPTION OF THE DRAWINGS

The invention will now be described in detail, by way of example, with the aid of the accompanying drawings, in which:

FIG. 1 shows a portion of a cigarette packer, viewed in a schematic front elevation and partly as a block diagram, comprising a unit for feeding and cutting a strip of wrapping material embodied in accordance with the present invention;

FIG. 2 shows the unit for feeding and cutting a strip of wrapping material according to the present invention, viewed in elevation and with parts in section;

FIG. 3 is a longitudinal section illustrating a detail of FIG. 2;

FIG. 4 illustrates a detail of FIG. 2, viewed schematically in elevation and exploded;

FIG. 5 shows a detail of the unit according to the invention, viewed schematically in perspective;

FIG. 5a is an enlarged detail of FIG. 5;

FIG. 6 shows a detail of FIG. 2, in elevation, illustrated in a plurality of operating positions;

FIG. 7 illustrates a length of strip material, viewed in plan, from which single leaves are cut;

FIG. 8 illustrates a packet of cigarettes, shown schematically and in perspective, furnished with an inner wrapper fashioned from a leaf of wrapping material as in FIG. 7.

### DESCRIPTION OF THE PREFERRED EMBODIMENTS

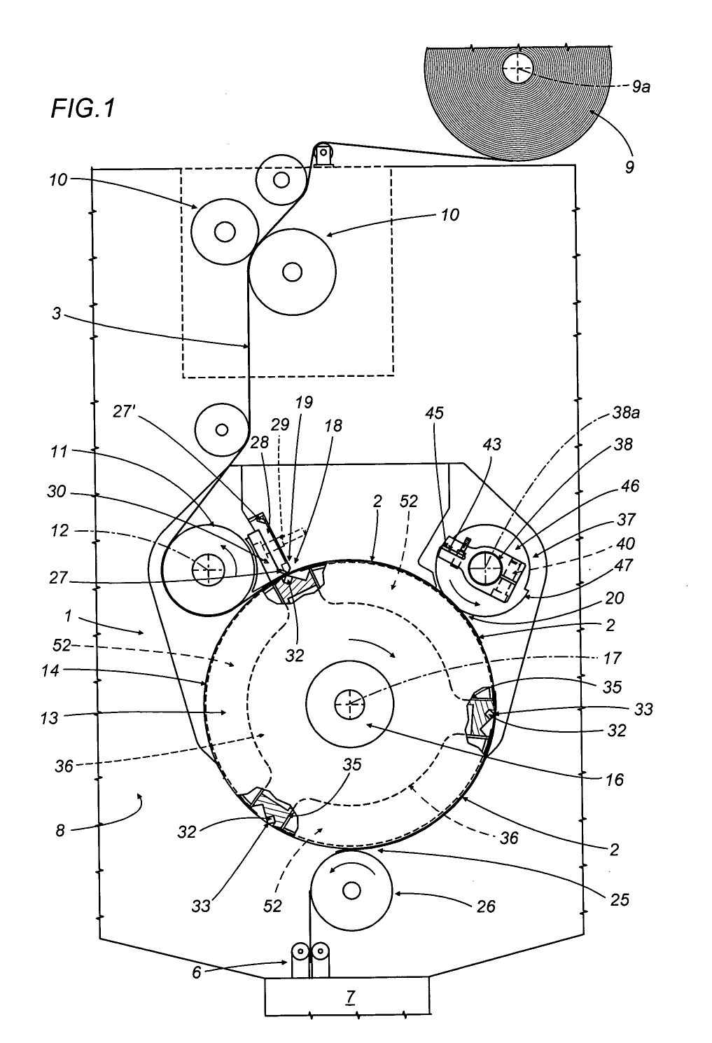

Referring to FIG. 1 of the drawings, 1 denotes a feeding and cutting unit, in its entirety, by which discrete lengths, or leaves 2, are cut from a continuous strip 3 of wrapping material (FIG. 7); in the example described and illustrated, the strip in question is a strip 3 of metal foil paper used to fashion the inner wrapper 4 for a packet 5 of cigarettes as in FIG. 8.

The leaves 2 are directed, for example through feed and guide means shown schematically as a pair of conveyor belts denoted 6, toward a processing station that consists in the folding equipment of a cigarette packer, represented in its entirety as a block denoted 7.

The unit 1 is carried by a vertical bulkhead 8 constituting part of the frame of the cigarette packer 7.

The strip 3 is decoiled from a roll 9, rotatable about a horizontal axis 9a extending normal to the bulkhead 8, by feed means that consist in a pair of pinch rolls 10 rotating substantially tangential one to another, and directed first over a diverting roller 11 rotatable about an axis 12 parallel to the axis 9a of the roll 9, then onto a support and feed conveyor consisting in a drum 13.

The drum 13 presents a cylindrical surface 14 furnished with holes 15 (FIG. 5) connected to a source of negative pressure not illustrated, and is mounted to a shaft 16 rotatable clockwise as viewed in FIG. 1 about an axis 17 lying parallel to the axis 12 of the diverting roller 11.

As the strip 3 advances on the drum 13, which is set in rotation at a tangential velocity greater than that of the feed means 10, it is divided up at a first operating station 18 into single leaves 2 by first cross cutting means denoted 19 in their entirety.

Likewise as the leaves 13 advance on the drum 13, a transverse tear-off line 21 and a longitudinal tear-off line 22 (FIG. 7) are impressed or scored on each one at a second operating station 20.

The two lines 21 and 22 in question, produced respectively by second and third cutting means that will shortly be described in detail, combine to create a line 23 of “L” shape located at one corner of the leaf 2 and delimiting a portion 24, referred to as a “pull”, such as can be detached from the inner wrapper 4 at the moment when the packet 5 of cigarettes is first opened (see FIGS. 7 and 8).

Proceeding downstream, from the second operating station 20, through a release station denoted 25 located substantially in diametrical opposition to the first operating station 18, the leaves 2 are taken up from the cylindrical surface 14 of the drum 13 by an aspirating roller 26 rotating in the counterclockwise direction, and advanced by this same roller through the aforementioned feed and guide means 6 to the processing station beyond.

The aforementioned first cutting means 19 include a blade 27 fixed to the bottom edge of a bar 28 of rectangular section, lying parallel to the axis 17 of the drum 13 and attached rigidly with relative screw means 29 to a block 30 associated rigidly in its turn with the bulkhead 8.

The blade 27, which thus extends parallel to the axis 17, is of length substantially equal to the transverse dimension of the strip 3 and presents a cutting edge 31 riding substantially tangential to a straight line generator of the drum 13.

The blade 27 is designed to divide the strip 3 into single leaves 2 by operating in conjunction with each one of three angularly equispaced anvil blades 32 rigidly associated with the drum 13 and affording sharp edges 33, such as will sever the strip 3 along transverse cut lines 34.

More exactly, the anvil blades 32 are fitted to the ends of respective radial arms 35 that project from a cylindrical hub 36 constituting a portion of the drum 13 keyed directly to the shaft 16.

Significantly, the edge of the bar 28 opposite to the edge carrying the blade 27 is equipped with a spare blade denoted 27′. This additional blade 27′ can be positioned in the operating station 18 by removing the screw means 29 and rotating the bar 28 through 180° relative to the block 30.

The second and third cutting means are rigidly associated one with another and operate likewise in conjunction with the drum 13 at the same second station 20, both being incorporated into a rotary device 37 mounted to a shaft 38 and set in motion counterclockwise about an axis 38a lying parallel to the axis 17 of the drum. Thus, the shaft 38 affords common rotary means of support for the second and third cutting means.

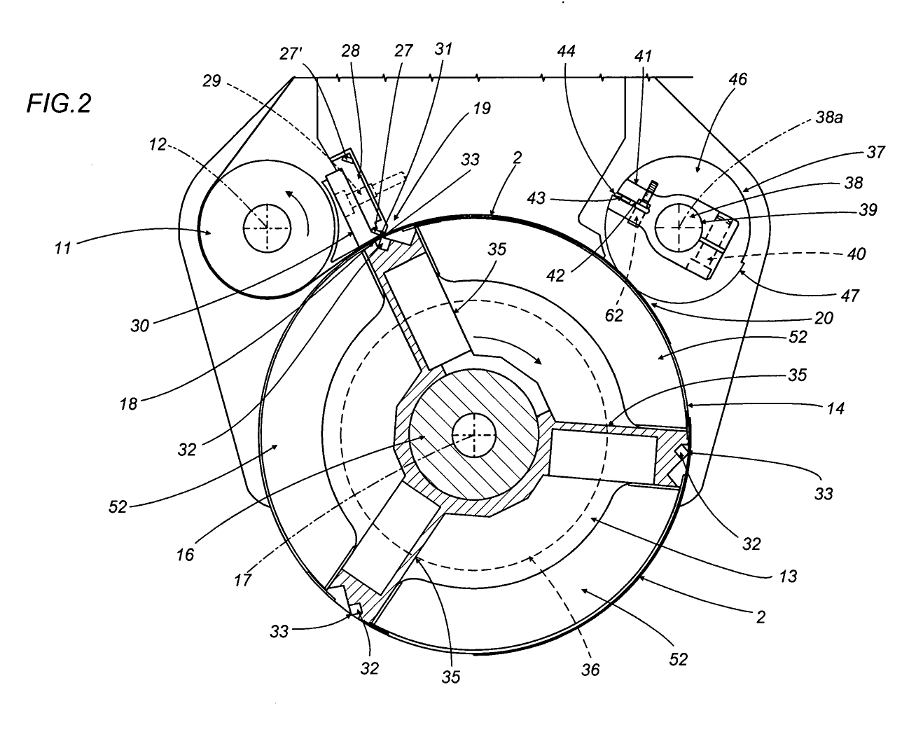

Referring to FIGS. 2, 3 and 6, the shaft 38 carries a substantially tubular element 39 equipped with screw clamp means 40 acting on the selfsame shaft 38, and a radial arm 41 occupying a position diametrically opposite the clamp means, of which the free end presents a transverse slot 42 aligned on a radial plane, accommodating a blade 43 with a cutting edge 44 disposed parallel to the axis 38a of the shaft 38 and substantially equal in length to the transverse tear-off line 21.

The tubular element 39 and the blade 43 together constitute the second cutting means, denoted 45 in their entirety, by which each leaf 2 is scored with a transverse tear-off line 21 extending a certain distance from one longitudinal edge of the leaf 2 toward the middle of the selfsame leaf.

Also mounted to the shaft 38 of the rotary means of support, and rigidly associated with the tubular element 39, is a disc 46 with a cutting edge 47 of predetermined angular width.

The disc 46 constitutes the third cutting means, denoted 48 in their entirety, by which each leaf 2 will be scored with a longitudinal tear-off line 22 extending from the innermost end of the relative transverse line 21 to one end of the leaf 2.

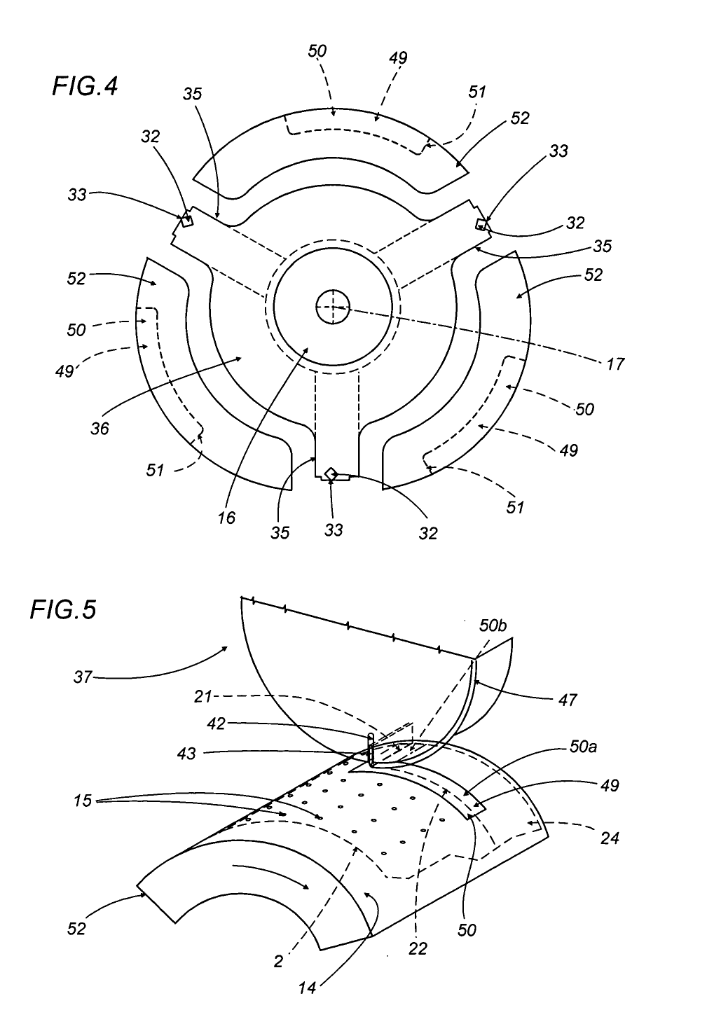

Embodied thus, the second cutting means 45 and the third cutting means 48 operate in conjunction with anvil means 49 (see FIGS. 4 and 5) rigidly associated with the drum 13 and consisting in three angularly equispaced inserts 50, each positioned at a predetermined distance from a respective anvil blade 32, which are embedded in respective seats 51 afforded by sectors 52 interposed between the three radial arms 35 aforementioned and breasted with the cylindrical surface of the hub 36.

As illustrated in FIG. 5, the inserts 50 are “L” shaped and serve each to establish two striking surfaces of which the surface interacting with the cutting edge 47 of the disc 46 is denoted 50a, and the surface interacting with the cutting edge 44 of the blade 43 is denoted 50b. Both the surfaces 50a and 50b are proportioned, in the longitudinal and the transverse directions, so that the blades of the second and third cutting means 45 and 48 can be adjusted for position without the need to replace the anvil means 49.

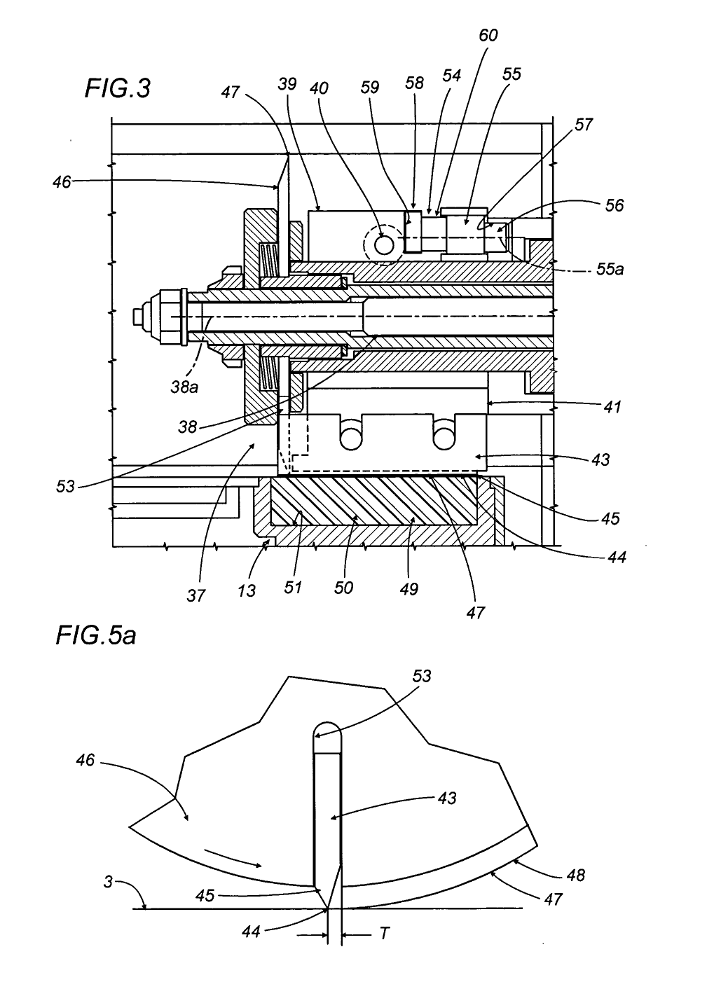

As indicated in FIGS. 3, 5 and 5a, the disc 46 presents a radial slot 53 and is also positioned angularly on the supporting shaft 38 in such a way that this same slot 53 will be located in alignment with the aforementioned slot 42 presented by the radial arm 41 of the tubular element 39, and thus occupiable by one end of the relative blade 43.

The cutting edge 47 of the disc 46 is positioned such that the downstream end, considered relative to its direction of rotation, coincides with the mouth of the slot 53 afforded by the disc 46 and is therefore placed in close proximity to one end of the cutting edge 44 presented by the blade 43. The distance separating one cutting edge 44 from the other cutting edge 47 establishes a stretch T of predetermined length coinciding, on the finished leaf 2, with a corresponding stretch T joining the pull portion 24 to the main body of the leaf 2.

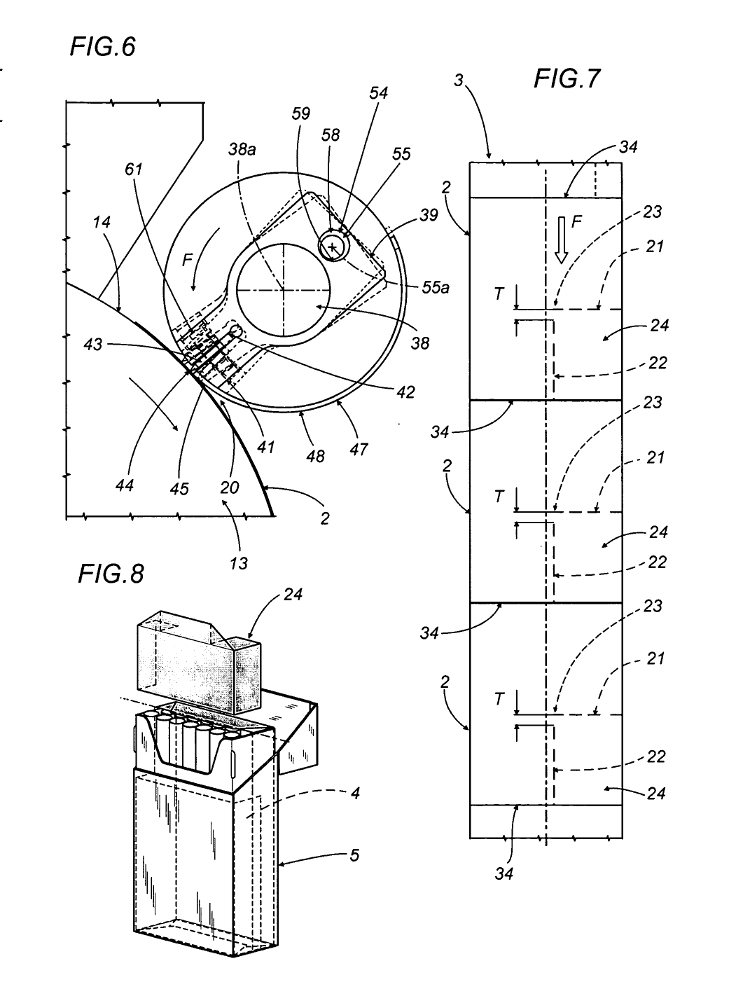

With reference to FIGS. 3 and 6, in particular, 54 denotes means, in their entirety, by which to adjust the angular position of the second and third cutting means 45 and 48 on the supporting shaft 38, hence also the timing of their stroke relative to that of the first cutting means 19.

More precisely, the adjustment means 54 comprise a shaft 55, centered on an axis 55a parallel to the axis 38a of the supporting shaft 38, of which one end 56 is insertable in a recess 57 afforded by a fixed annular element coaxial with the shaft 38, whilst the other end carries a cylindrical head 58 mounted eccentrically to the selfsame shaft 55 and coupled with a cylindrical bore 59 presented by the tubular element 39.

In operation, should the need arise to adjust the position of the transverse tear-off line 21 on the single leaf 2, or to change the size of the pull portion 24, the clamp means 40 are loosened to free the tubular element 39 on the supporting shaft 38, whereupon the shaft 55 is turned on its axis 55a, using a suitable tool applied to an intermediate portion denoted 60.

Rotating the shaft 55 one way or the other, the head 58 will cause the tubular element 39 to shift about the axis 38a of the supporting shaft 38 and thus induce a corresponding angular adjustment of the blade 43 and the disc 46.

As discernible from FIGS. 2 and 6, the blade 43 is also adjustable for radial position by releasing relative clamp means 61 (FIG. 6) and resetting cone point set screws denoted 62.

In addition, it will be seen that the striking surface 50b offered to the cutting edge 44 of the blade 43 is proportioned to allow an appreciable degree of angular adjustment without the need for parts to be replaced.

Finally, the aforementioned sectors 52 of the drum 13 will be embodied in carbon fiber and the respective inserts 50 in metallic and/or resilient material, and interchangeable.

The strip material 3 will be caused to slide on the cylindrical surface 14 of the drum 13, given that the tangential velocity of the drum is greater than the linear velocity of the strip 3 decoiled by the pinch rolls 10 and advanced by the power driven diverter roller 11, as mentioned previously, and substantially equal to the tangential velocity of the second and third cutting means 45 and 48.

Accordingly, the transverse stroke made by the second cutting means 45 must take place without any sliding motion of the material, that is, after the leaf 2 has been separated from the strip 3 by the first cutting means 19, otherwise the leaf 2 could be torn by the second cutting means 45 on or around the transverse tear-off line 21.

1. A unit for feeding and cutting into lengths a strip of wrapping material, comprising:
a conveyor on which to support and advance the strip;
first cutting means, operating cyclically and in conjunction with the conveyor supporting and advancing the strip, by which the selfsame strip is divided transversely into single leaves of predetermined length;
second cutting means, operating cyclically and in conjunction with the conveyor supporting and advancing the strip, serving to score at least one transverse tear-off line on each leaf;
third cutting means, operating cyclically and in conjunction with the conveyor supporting and advancing the strip, serving to score a longitudinal tear-off line combining with the transverse tear-off line to delimit a removable portion of the leaf;
wherein the second and third cutting means are rigidly associated one with another and form part of a common rotary device.

2. A unit as in claim 1, wherein the second and third cutting means combine at one and the same operating station to define a cutting edge of “L” profile interacting with at least one set of anvil means presented by the conveyor.

3. A unit as in claim 2, wherein the conveyor consists in a rotating drum and the rotary device comprises a shaft, of which the axis extends parallel to the axis of the drum, carrying second cutting means embodied as a radial blade and third cutting means embodied as a disc blade.

4. A unit as in claim 3, comprising means by which to adjust the timing of the stroke made by the second and the third cutting means, relative to that of the first cutting means.

5. A unit as in claim 4, wherein adjustment means comprise means by which to adjust the angular position of the second and third cutting means about the axis of the relative supporting shaft.

6. A unit as in claim 5, wherein the drum is equipped with a plurality of anvil blades, angularly equispaced and combining with a fixed blade to provide the first cutting means.

7. A unit as in claim 6, wherein the drum presents a plurality of sectors, angularly equispaced and identical in number to the anvil blades, each presenting an outer surface fashioned with a respective seat such as will accommodate an insert providing the anvil means offered to the cutting edge of “L” profile presented by the second and third cutting means.

8. A unit as in claim 7, wherein the sectors are embodied in carbon fiber and the inserts are embodied in metallic and/or resilient material and are interchangeable.

9. A method of cutting strip material into discrete lengths, including the steps of feeding a strip of wrapping material to a conveyor, severing the strip on transverse cut lines through the agency of first cutting means, cyclical in operation, so as to separate the single leaves, and scoring a succession of transverse lines and longitudinal lines on the strip with second and third cutting means to create a removable portion on each successive leaf, wherein the steps of scoring the longitudinal line and the transverse line occur in succession at a single operating station, and the step by which a cut is made on the transverse line to separate each leaf from the strip precedes at least the step of scoring the transverse line.

10. A unit as in claim 1, comprising means by which to adjust the timing of the stroke made by the second and the third cutting means, relative to that of the first cutting means.

11. A unit as in claim 10, wherein adjustment means comprise means by which to adjust the angular position of the second and third cutting means about the axis of the relative supporting shaft.

12. A unit as in claim 3, wherein the drum is equipped with a plurality of anvil blades, angularly equispaced and combining with a fixed blade to provide the first cutting means.

13. A unit as in claim 2, comprising means by which to adjust the timing of the stroke made by the second and the third cutting means, relative to that of the first cutting means.

14. A unit as in claim 13, wherein adjustment means comprise means by which to adjust the angular position of the second and third cutting means about the axis of the relative supporting shaft.

15. A unit as in claim 3, wherein adjustment means comprise means by which to adjust the angular position of the second and third cutting means about the axis of the relative supporting shaft.
